(19) United States
(12) Patent Application Publication
(10) Pub. No.: US 2014/0132420 A1
(43) Pub. Date: May 15, 2014

(54) Apparatus and Method for Multi-Mode and Multi-Depth Resistivity Measurements

(71) Applicant: GREATWALL DRILLING COMPANY, Beijing (CN)

(72) Inventors: Naizheng Liu, Beijing (CN); Qihui Zhao, Beijing (CN); Yuzhou Lu, Beijing (CN); Rui Bai, Beijing (CN); Jing Li, Houston, TX (US); Ce Liu, Sugar Land, TX (US); Yonghe Li, Beijing (CN)

(73) Assignee: GREATWALL DRILLING COMPANY, Beijing (CN)

(21) Appl. No.: 13/672,985

(22) Filed: Nov. 9, 2012

(51) Int. Cl. H04B 1/44; G01V 3/18

(52) U.S. Cl. CPC H04B 1/44; G01V 3/18
USPC 340/853.1

(57) ABSTRACT

An apparatus for measuring formation resistivity includes a tool body and multiple transceivers deployed on the tool body. Each transceiver includes a switch to control the transceiver to switch between a transmitter mode and a receiver mode. At least one transceiver acting in the transmitter mode transmits compensating signals. At least one transceiver acting in the transmitter mode transmits measuring signals. At least a pair of transceivers acting in the receiver mode which are positioned on two sides of the transceiver transmitting compensating signals and substantially symmetrical with respect to it receives the compensating signals and the measuring signals. The pair of transceivers acting in the receiver mode measures the amplitudes and phases of the compensating signals and the measuring signals in a sequential order and computes a compensated amplitude ratio and a compensated differential phase accordingly. A corresponding method for measuring formation resistivity is also provided.

### FIELD OF THE INVENTION

The present invention relates generally to the field of electrical resistivity well logging. More particularly, the invention relates to an apparatus and a method for making measurements of resistivity of a subterranean formation adjacent the wellbore.

### BACKGROUND OF THE INVENTION

The use of electrical measurements for gathering of downhole information, such as logging while drilling (“LWD”), measurement while drilling (“MWD”), and wireline logging system, is well known in the oil industry. Such technology has been utilized to obtain earth formation resistivity (or conductivity; the terms “resistivity” and “conductivity”, though reciprocal, are often used interchangeably in the art.) and various rock physics models (e.g. Archie's Law) can be applied to determine the petrophysical properties of a subterranean formation and the fluids therein accordingly. As known in the prior art, resistivity is an important parameter in delineating hydrocarbon (such as crude oil or gas) and water contents in the porous formation. It is preferable to keep the borehole in the pay zone (the formation with hydrocarbons) as much as possible so as to maximize the recovery.

However, the formation resistivity measurements suffer disturbance from the temperature drift of measuring circuitry and antennas and irregularity of the surface of the borehole. To eliminate error factors as mentioned above and improve the accuracy of measurements, several systems and methods have been developed for making formation resistivity measurements as follows.

FIG. 1 illustrates a prior art of a “borehole compensation technique.” A tool body 102 is deployed with a pair of transmitters T1 and T2 and a pair of receivers R1 and R2. The pair of receivers R1 and R2 is located between the pair of transmitters T1 and T2, which are disposed symmetrically with respect to the midpoint of the pair of receivers R1 and R2 (the distance from the midpoint of the pair of receivers R1 and R2 to the transmitters T1 and T2 are both equal to L).

To make resistivity and dielectric constant measurements, the two transmitters T1 and T2 transmit electromagnetic signals in a sequential order and the receivers R1 and R2 receive and measure the electromagnetic signals from the transmitters T1 and T2. In frequency domain, the measured electromagnetic signals at the receivers R1 and R2 after one cycle of measurements can be expressed as follows.

Ã_{R1}^{T1}=A_{R1}^{T1}·e^{jφ}^{_{R1}}^{^{T1}}=c_{T1}^{err}·c_{R1(T1)}^{err}·a_{R1}^{T1}·e^{j(φ}^{_{R1}}^{^{T1}}^{+φ}^{_{R1(T1)}}^{^{err}}^{+φ}^{_{T1}}^{^{err}}) (1)

Ã_{R2}^{T1}=A_{R2}^{T1}·e^{jφ}^{_{R2}}^{^{T1}}=c_{T1}^{err}·c_{R2(T1)}^{err}·a_{R2}^{T1}·e^{j(φ}^{_{R2}}^{^{T1}}^{+φ}^{_{R2(T1)}}^{^{err}}^{+φ}^{_{T1}}^{^{err}}) (2)

Ã_{R1}^{T2}=A_{R1}^{T2}·e^{jφ}^{_{R1}}^{^{T2}}=c_{T2}^{err}·c_{R1(T2)}^{err}·a_{R1}^{T2}·e^{j(φ}^{_{R1}}^{^{T2}}^{+φ}^{_{R1(T2)}}^{^{err}}^{+φ}^{_{T2}}^{^{err}}) (3)

Ã_{R2}^{T2}=A_{R2}^{T2}·e^{jφ}^{_{R2}}^{^{T2}}=c_{T2}^{err}·c_{R2(T2)}^{err}·a_{R2}^{T2}·e^{j(φ}^{_{R2}}^{^{T2}}^{+φ}^{_{R2(T2)}}^{^{err}}^{+φ}^{_{T2}}^{^{err}}) (4)

where Ã_{R1}^{T1}, Ã_{R2}^{T1}, Ã_{R1}^{T2}, and Ã_{R2}^{T2} are the measured electromagnetic signals at the receivers R1 and R2 in complex format, the superscripts and subscripts of Equations (1-4) represent the transmitters T1 or T2 and receivers R1 or R2 that are active when the signals are being measured; the complex quantities Ã_{R1}^{T1}, Ã_{R2}^{T1}, Ã_{R1}^{T2}, and Ã_{R2}^{T2} are composed of measured amplitudes A_{R1}^{T1}, A_{R2}^{T1}, A_{R1}^{T2}, and A_{R2}^{T2} and measured phases φ_{R1}^{T1}, φ_{R2}^{T1}, φ_{R1}^{T2}, φ_{R2}^{T2} correspondingly; where a_{R1}^{T1}, a_{R2}^{T1}, a_{R1}^{T2}, a_{R2}^{T2} and φ_{R1}^{T1}, φ_{R2}^{T1}, φ_{R1}^{T2}, φ_{R2}^{T2} are the formation related amplitude components and phase components and phase components in the measured electromagnetic signals at the receivers R1 and R2 when the transmitters T1 and T2 fire respectively; c_{T1}^{err}, c_{T2}^{err}, φ_{T1}^{err} and φ_{T2}^{err} are the transmitter induced errors in signal amplitude and phase respectively on the pair of receivers R1 and R2 when the transmitters T1 and T2 fire; c_{R1(T1)}^{err}, c_{R2(T1)}^{err}, φ_{R1(T1)}^{err} and φ_{R2(T2)}^{err} represent the receiver-induced errors in signal amplitude and phase respectively in the pair of receivers R1 and R2 when the transmitter T1 fires; c_{R1(T2)}^{err}, c_{R2(T2)}^{err}, φ_{R1(T2)}^{err} and φ_{R2(T2)}^{err} are the receiver-induced errors in signal amplitude and phase respectively in the pair of receivers R1 and R2 when the transmitter T2 fires.

Due to the symmetrical arrangement of the pair of transmitters T1 and T2 and the pair of receivers R1 and R2, both the receiver-induced errors and the transmitter induced errors, which may be caused by embedded antennas or corresponding circuits, can be cancelled out from the measured amplitudes and measured phases. Accordingly, the results of compensated measurements between electromagnetic signal amplitudes and phases on the receivers R1 and R2 for formation resistivity computation can become more accurate because only the formation related amplitude and phase components would be left in the compensated amplitude ratios and compensated differential phases. Corresponding mathematical algorithm can be shown in Equations (5-14) below.

To make compensated measurements between electromagnetic signal amplitudes and phases reflected on the receivers R1 and R2 for computing formation resistivity, the first step is to derive the complex ratios of the measured electromagnetic signals at the receiver R1 to the measured electromagnetic signals at the receiver R2 when the transmitters T1 and T2 fire respectively as follows.

$$\begin{matrix}{\tilde{ρ}}_{T 1} = \frac{{\tilde{A}}_{R 2}^{T 1}}{{\tilde{A}}_{R 1}^{T 1}} = \frac{{A}_{R 2}^{T 1} \cdot {e}^{{jφ}_{R 2}^{T 1}}}{{A}_{R 1}^{T 1} \cdot {e}^{{jφ}_{R 1}^{T 1}}} = \frac{{c}_{R 2 ( T 1 )}^{err}}{{c}_{R 1 ( T 1 )}^{err}} \cdot \frac{{a}_{R 2}^{T 1}}{{a}_{R 1}^{T 1}} \cdot {e}^{j ( {ϕ}_{R 2}^{T 1} - {ϕ}_{R 1}^{T 1} + {ϕ}_{R 2 ( T 1 )}^{err} - {ϕ}_{R 1 ( T 1 )}^{err} )} & ( 5 ) \\ {\tilde{ρ}}_{T 2} = \frac{{\tilde{A}}_{R 1}^{T 2}}{{\tilde{A}}_{R 2}^{T 2}} = \frac{{A}_{R 1}^{T 2} \cdot {e}^{{jφ}_{R 1}^{T 2}}}{{A}_{R 2}^{T 2} \cdot {e}^{{jφ}_{R 2}^{T 2}}} = \frac{{c}_{R 1 ( T 2 )}^{err}}{{c}_{R 2 ( T 2 )}^{err}} \cdot \frac{{a}_{R 1}^{T 2}}{{a}_{R 2}^{T 2}} \cdot {e}^{j ( {ϕ}_{R 1}^{T 2} - {ϕ}_{R 2}^{T 2} + {ϕ}_{R 1 ( T 2 )}^{err} - {ϕ}_{R 2 ( T 2 )}^{err} )} & ( 6 )\end{matrix}$$

After taking the complex ratio of the measured electromagnetic signals at the pair of receivers R1 and R2 at each transmitter antenna firing, the transmitter induced errors in signal amplitude and phase (c_{T1}^{err}, c_{T2}^{err}, φ_{T1}^{err} and φ_{T2}^{err}) are cancelled in Equations (5-6).

The second step is to take multiplication of \tilde{ρ}_{T1} and \tilde{ρ}_{T2} from Equations (5) and (6) as follows.

$${\tilde{ρ}}_{c} = {\tilde{ρ}}_{T 1} \cdot {\tilde{ρ}}_{T 2} = \frac{{\tilde{A}}_{R 2}^{T 1}}{{\tilde{A}}_{R 1}^{T 1}} \cdot \frac{{\tilde{A}}_{R 1}^{T 2}}{{\tilde{A}}_{R 2}^{T 2}} = \frac{{A}_{R 2}^{T 1} \cdot {e}^{{jφ}_{R 2}^{T 1}}}{{A}_{R 1}^{T 1} \cdot {e}^{{jφ}_{R 1}^{T 1}}} \cdot \frac{{A}_{R 1}^{T 2} \cdot {e}^{{jφ}_{R 1}^{T 2}}}{{A}_{R 2}^{T 2} \cdot {e}^{{jφ}_{R 2}^{T 2}}} = \frac{{a}_{R 2}^{T 1}}{{a}_{R 1}^{T 1}} \cdot \frac{{a}_{R 1}^{T 2}}{{a}_{R 2}^{T 2}} \cdot {e}^{j [ ( {ϕ}_{R 2}^{T 1} - {ϕ}_{R 1}^{T 1} ) + ( {ϕ}_{R 1}^{T 2} - {ϕ}_{R 2}^{T 2} ) ]} \qquad ( 7 )$$

After taking multiplication of \tilde{ρ}_{T1} and \tilde{ρ}_{T2}, the receiver-induced errors in amplitude and phase are cancelled too, based on the arrangement of symmetrical transmitters T1 and T2 and the receiver property consistency during the time period between the firing of transmitter T1 and the firing of transmitter T2 in a measurement cycle (c_{R1(T1)}^{err}=c_{R1(T2)}^{err}, c_{R2(T1)}^{err}=c_{R2(T2)}^{err}, φ_{R1(T1)}^{err}=φ_{R1(T2)}^{err}, and φ_{R1(T1)}^{err}=c_{R2(T2)}^{err}). In Equation (7), only the formation related signal amplitude ratio and phase difference are left. The compensated complex ratio \tilde{ρ}_{c}, derived out from the measurements by a pair of transmitters and a pair of receivers can automatically eliminate transmitter induced errors and receiver-induced errors in the compensated amplitude ratio and compensated differential phase.

The magnitude of the compensated complex ratio \tilde{ρ}_{c}, represents a compensated amplitude ratio of the measured electromagnetic signals at the pair of receivers R1 and R2. The phase of the compensated complex ratio \tilde{ρ}_{c}, represents a compensated differential phase of the measured electromagnetic signals at the pair of receivers R1 and R2. Both of them can be derived out from measured signals as follows.

$$\begin{matrix}{ρ}_{c} = \vert \tilde{ρ} \vert = \frac{{A}_{R 2}^{T 1}}{{A}_{R 1}^{T 1}} \cdot \frac{{A}_{R 1}^{T 2}}{{A}_{R 2}^{T 2}} & ( 8 ) \\ {Δφ}_{c} = arg ( \tilde{ρ} ) = ( {φ}_{R 2}^{T 1} - {φ}_{R 1}^{T 1} ) + ( {φ}_{R 1}^{T 2} - {φ}_{R 2}^{T 2} ) & ( 9 )\end{matrix}$$

Alternatively, the compensated amplitude ratio and the compensated differential phase in Equations (8-9) can be scaled down to the range of uncompensated measurements (single transmitter antenna measurements) by taking square roots of the compensated complex ratios as shown below. The benefits to scale down the compensated amplitude ratio and the compensated differential phase to the range of uncompensated measurements are that users still can use the conversion chart (converting the amplitude ratio and differential phase to formation resistivity) of uncompensated measurements to compute the formation resistivity according to the scaled down compensated amplitude ratio and differential phase.

$$\begin{matrix}{\tilde{ρ}}_{c}^{′} = \sqrt{\frac{{\tilde{A}}_{R 2}^{T 1}}{{\tilde{A}}_{R 1}^{T 1}} \cdot \frac{{\tilde{A}}_{R 1}^{T 2}}{{\tilde{A}}_{R 2}^{T 2}}} & ( 10 ) \\ {ρ}_{c}^{′} = \vert \tilde{ρ} \vert = \sqrt{\frac{{A}_{R 2}^{T 1}}{{A}_{R 1}^{T 1}} \cdot \frac{{A}_{R 1}^{T 2}}{{A}_{R 2}^{T 2}}} & ( 11 ) \\ {Δφ}_{c}^{′} = \frac{( {φ}_{R 2}^{T 1} - {φ}_{R 1}^{T 1} ) + ( {φ}_{R 1}^{T 2} - {φ}_{R 2}^{T 2} )}{2} & ( 12 )\end{matrix}$$

where \tilde{ρ}_{c}′ has a magnitude equivalent to an uncompensated complex ratio; where compensated ratio ρ_{c}′ and differential phase Δφ_{c}′ are in the same magnitude order with an uncompensated ratio and uncompensated differential phase (herein uncompensated amplitude ratio and uncompensated differential phase mean the amplitude ratio and differential phase measured by a single transmitter firing) respectively.

The definitions of the compensated ratio and phase expressed by Equation (8) and (9) are mathematically equivalent to the definitions in Equations (11) and (12). Either of the two definitions can be applied as long as the definitions used in calculating the compensated amplitude ratio and compensated differential phase from tool measurements must be consistent with the ones used in creating the conversion chart.

However, based on results of the mathematical deduction through Equations (1-7), only the formation related amplitude and phase components would be left in the compensated amplitude ratios and compensated differential phases as stated in Equations (11-12). Therefore, the derived compensated amplitude ratio and compensated differential phase theoretically only represent the formation related amplitude ratio and differential phase as shown below.

$$\begin{matrix}{ρ}_{c}^{′} = \vert {\tilde{ρ}}_{c}^{′} \vert = \sqrt{\frac{{a}_{R 2}^{T 1}}{{a}_{R 1}^{T 1}} \cdot \frac{{a}_{R 1}^{T 2}}{{a}_{R 2}^{T 2}}} & ( 13 ) \\ {Δφ}_{c}^{′} = \frac{( {ϕ}_{R 2}^{T 1} - {ϕ}_{R 1}^{T 1} ) + ( {ϕ}_{R 1}^{T 2} - {ϕ}_{R 2}^{T 2} )}{2} & ( 14 )\end{matrix}$$

The borehole compensation technique disclosed in FIG. 1 not only can cancel the transmitter induced errors in signal amplitude and phase, but also can cancel the receiver-induced errors in signal amplitude and phase by the arrangement of symmetrical transmitters.

FIG. 2 shows another prior art of a resistivity tool employing compensation mechanism. In FIG. 2, the application with different numbers of pairs of transmitters T1 and T2 and receivers are disclosed. Multiple transmitter-receiver offsets can help multiple depth of formation investigation. Also, the larger the transmitter-receiver offset is, the greater the depth of formation investigation could be achieved.

However, the need of a pair of transmitters positioned on two sides of a pair of receivers would increase the length of a measurement tool significantly, especially for the measurement tool for multiple depth of investigation, where multiple pairs of transmitters are required. Furthermore, the longer the length of the measurement tool is, the more side effects and rugosity effects would be caused. Also, increasing the length of the measurement tool would also increase its manufacturing cost.

As described above, a need exists for an improved apparatus and method for measurements of formation resistivity.

A further need exists for an improved apparatus and method for measurements of formation resistivity utilizing a measurement tool without a prolonged length to reduce side effects and manufacturing costs.

A further need exists for an improved apparatus and method for measurements of formation resistivity utilizing a measurement tool with transceivers which combine the transmitter with the receiver to decrease the length of the tool body.

A further need exists for an improved apparatus and method for measurements of formation resistivity utilizing a measurement tool with corresponding electronic circuits for the transceivers to process electromagnetic signals.

The present embodiments of the apparatus and the method meet these needs and improve on the technology.

### SUMMARY OF THE INVENTION

This section provides a general summary of the disclosure, and is not a comprehensive disclosure of its full scope or its entire feature.

In one preferred embodiment, an apparatus for measuring formation resistivity in logging while drilling application includes a tool body, and multiple transceivers deployed on the tool body; each transceiver further comprising a switch to control the transceiver to switch between a transmitter mode and a receiver mode; and at least one transceiver acting in the transmitter mode to transmit compensating signals, at least one transceiver acting in the transmitter mode to transmit measuring signals, and at least a pair of transceivers acting in the receiver mode, positioned on two sides of the transceiver transmitting compensating signals, and substantially symmetrical with respect to it, to receive the compensating signals and the measuring signals.

In some embodiments, the pair of transceivers acting in the receiver mode measures the amplitudes and phases of the compensating signals and the measuring signals in a sequential order and computes a compensated amplitude ratio and a compensated differential phase accordingly.

In some embodiments, each transceiver comprises a transmitter circuit and a receiver circuit configured to generate and receive compensating and measuring signals, respectively.

In some embodiments, the apparatus further includes a compensation controller coupled to each transceiver to help determine receiver-induced error factors in amplitude and phase reflected in the pair of transceivers acting in the receiver mode when the compensating signals are transmitted for calibrating receiver-induced error in amplitude and phase reflected in the pair of transceivers acting in the receiver mode when the measuring signals are transmitted.

In some embodiments, the apparatus further includes a processor coupled to the transceivers and the compensation controller and configured to help the compensation controller determine receiver-induced error factors in amplitude and phase reflected in the pair of transceivers acting in the receiver mode when the compensating signals are transmitted and to help compute the compensated amplitude ratio and the compensated differential phase after the measuring signals are transmitted.

In some embodiments, the apparatus further includes a storage device coupled to the processor and stored with a conversion chart, which is for converting the compensated amplitude ratio and the compensated differential phase into corresponding formation resistivity.

In some embodiments, the compensated amplitude ratio is expressed by an equation

$${ρ}_{c} = \sqrt{\frac{{A}_{R 1}^{Tc}}{{A}_{R 2}^{Tc}} \cdot \frac{{A}_{R 2}^{Tm}}{{A}_{R 1}^{Tm}}}$$

where A_{R1}^{Tm} and A_{R2}^{Tm} represent signal amplitudes of the measuring signals measured at the pair of transceiver acting in the receiver mode respectively when the measuring signals are transmitted; superscript Tm represents the transceiver transmitting measuring signals; subscript R2 represents the transceiver acting in the receiver mode; and subscript R1 represents another transceiver acting in the receiver mode which is closer to the transceiver transmitting measuring signals than the R2 is.

In some embodiments, the corresponding compensated differential phase is expressed by an equation

$$Δ {φ}_{c} = \frac{( {φ}_{R 1}^{Tc} - {φ}_{R 2}^{Tc} ) + ( {φ}_{R 2}^{Tm} - {φ}_{R 1}^{Tm} )}{2}$$

where φ_{R1}^{Tm} and φ_{R2}^{Tm} represent the signal phase of the measuring signals measured at the pair of transceiver acting in the a receiver mode respectively when the measuring signals are transmitted; superscript Tm represents the transceiver transmitting measuring signals; subscript R2 represents the transceiver acting in the receiver mode; and subscript R1 represents another transceiver acting in the receiver mode which is closer to the transceiver transmitting measuring signals than the R2 is.

In some embodiments, the multiple transceivers are substantially equally spaced from each other.

In other embodiments, the compensated amplitude ratio and the compensated differential phase are average results of multiple compensated amplitude ratios and the compensated differential phases computed from multiple pairs of transceivers acting in the receiver mode which have substantially the same distance from the midpoint of the pairs of transceivers to the transceiver transmitting measuring signals.

In other embodiments, the multiple pairs of transceivers acting in the receiver mode share substantially the same zone of formation from the midpoint of them to the transceiver transmitting measuring signals.

In other embodiments, each transceiver comprises at least one antenna for transmitting or receiving signals.

In another embodiment, the tool body is a drilling collar.

In another preferred embodiment, a logging while drilling tool includes a tool body, one or more transceivers acting in a transmitter mode to transmit measuring signals, and a receiving unit formed by a pair of transceivers acting in a receiver mode and a transceiver acting in the transmitter mode to transmit compensating signals and positioned substantially at the midpoint of the pair of the transceivers acting in receiver mode.

In some embodiments, the pair of transceivers acting in the receiver mode measures the amplitudes and phases of the compensating signals and the measuring signals in a sequential order and computes a compensated amplitude ratio and a compensated differential phase accordingly.

In some embodiments, the logging while drilling tool further includes a compensation controller coupled to the transceivers to help determine receiver-induced error factors in amplitude and phase reflected in the pair of transceivers acting in the receiver mode when the compensating signals are transmitted for calibrating receiver-induced error in amplitude and phase reflected in the pair of transceivers acting in the receiver mode when the measuring signals are transmitted.

In some embodiments, the transceivers are substantially equally spaced from each other.

In another preferred embodiment, a method for measuring formation resistivity in a subterranean borehole includes deploying a tool body in the borehole, firing the transceiver acting in the transmitter mode to transmit compensating signals, utilizing the pair of transceivers acting in the receiver mode to receive the compensating signals and measure the amplitudes and phases of them, firing the transceiver acting in the transmitter mode to transmit measuring signals, utilizing the pair of transceiver acting in the receiver mode to receive the measuring signals and measure the amplitudes and phases of them, and computing a compensated amplitude ratio and a compensated differential phase based on the amplitudes and phases of the compensating signals and the measuring signals.

In some embodiments, the tool body deployed with an array of transceivers includes at least one transceiver acting in a transmitter mode to transmit measuring signals, at least one transceiver acting in a transmitter mode to transmit compensating signals, and at least a pair of transceivers acting in a receiver mode to receive the compensating signals and the measuring signals; the transceiver transmitting compensating signals being positioned substantially at the midpoint of the pair of transceivers acting in a receiver mode.

In some embodiments, the method further includes averaging the compensated amplitude ratios and the compensated differential phases computed from multiple pairs of transceivers acting in the receiver mode which have substantially the same distance from the midpoint of the pairs of transceivers acting in the receiver mode to the transceiver transmitting measuring signals for improving measurement accuracy.

In some embodiments, the multiple pairs of transceivers acting in the receiver mode share a substantially the same zone of formation from the midpoint of them to the transceiver transmitting measuring signals.

In some embodiments, the method further includes providing a compensation controller coupled to the transceivers to help determine receiver-induced error factors in amplitude and phase reflected in the pair of transceivers acting in the receiver mode when the compensating signals are transmitted to reduce receiver-induced errors in amplitude and phase reflected in the pair of transceiver acting in the receiver mode when the measuring signals are transmitted.

In other embodiments, the method further includes providing a conversion chart to help convert the computed compensated amplitude ratio and the compensated differential phase into corresponding formation resistivity.

### BRIEF DESCRIPTION OF THE DRAWINGS

The drawings described herein are for illustrating purposes only of selected embodiments and not all possible implementation and are not intended to limit the scope of the present disclosure.

The detailed description will be better understood in conjunction with the accompanying drawings as follows:

FIG. 1 illustrates a prior art of resistivity tool employing compensation mechanism with a pair of transmitters and a pair of receivers.

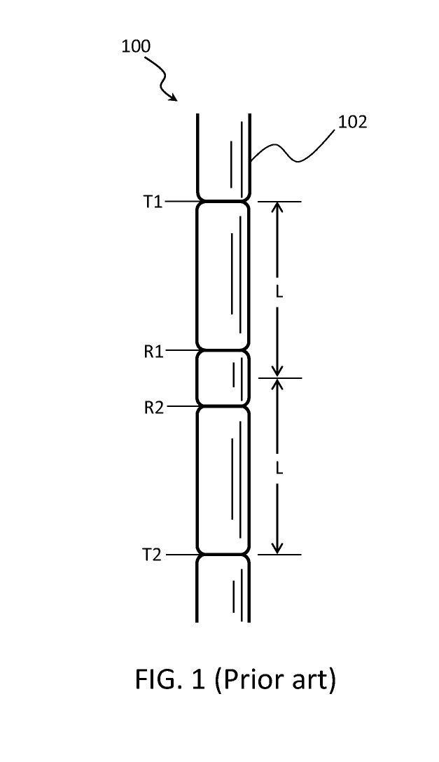

FIG. 2 illustrates another prior art of resistivity tool employing compensation mechanism.

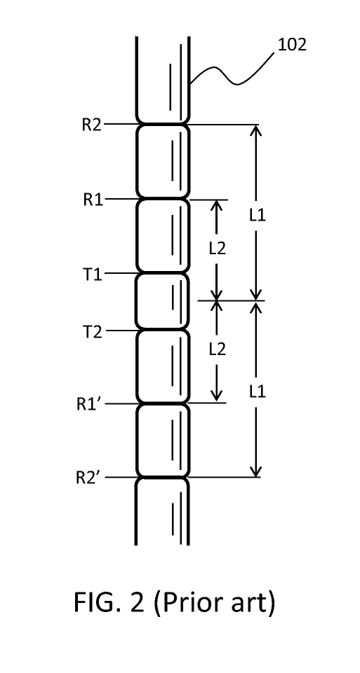

FIG. 3A illustrates a perspective view of a tool body deployed with multiple transceivers and switches according to some embodiments of the present invention.

FIG. 3B illustrates a schematic representation, partially in block diagram form, of an apparatus including multiple transceivers, switches, transmitter circuits, receiver circuits, compensation controllers, a processor, and a storage device for formation resistivity measurements according to some embodiments of the present invention.

FIG. 4A is a matrix of measured phases after one cycle of measurement when N transceivers in total are in use.

FIG. 4B is a matrix of measured amplitudes after one cycle of measurement when N transceivers in total are in use.

FIG. 5A illustrates the first measurement mode of one embodiment (7 transceivers) of the present invention.

FIG. 5B illustrates the second measurement mode of one embodiment (7 transceivers) of the present invention.

FIG. 6 is a table of the number of each depth of investigation being measured in each mode with 9 transceivers in use.

FIG. 7 is a flow chart of a method for measuring formation resistivity according to some embodiments of the present invention.

The present embodiments are detailed below with reference to the listed Figures.

### DETAILED DESCRIPTION OF THE EMBODIMENTS

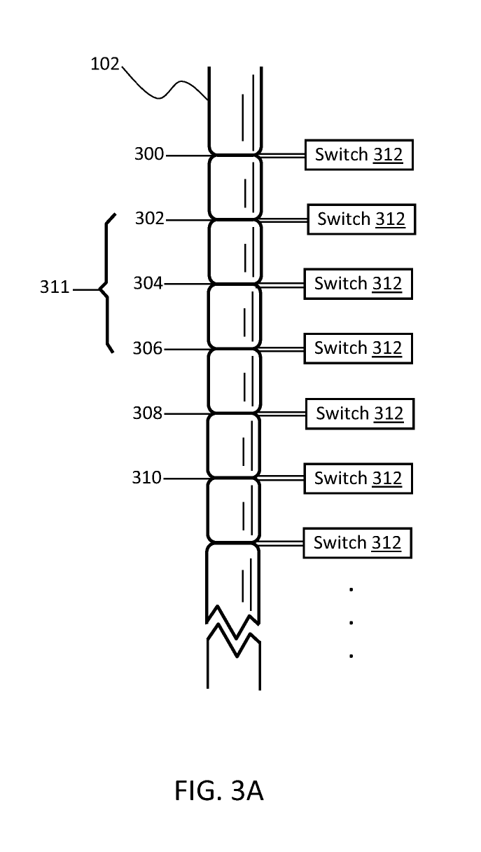

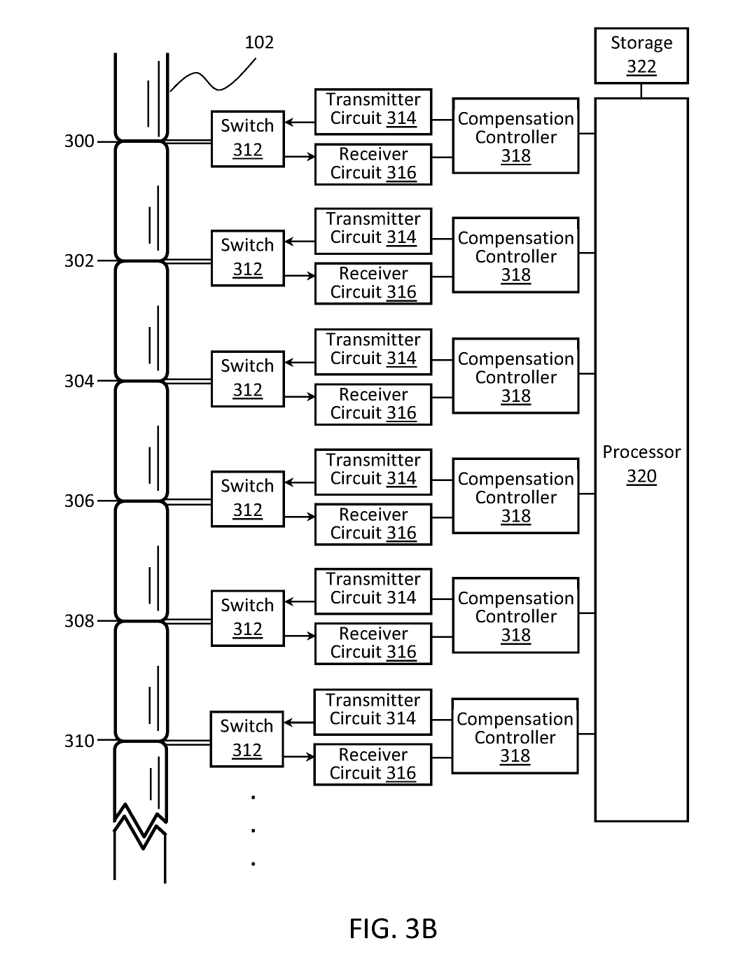

FIG. 3A illustrates a perspective view of a tool body 102 deployed with multiple transceivers: a first transceiver 300, a second transceiver 302, a third transceiver 304, a fourth transceiver 306, a fifth transceiver 308, and a sixth transceiver 310. Each transceiver can include a switch 312 to control the transceiver to switch between a transmitter mode and a receiver mode. In other words, each transceiver can act as a transmitter or as a receiver. Each of the transceiver can also include at least one antenna for transmitting or receiving electromagnetic signals to measure formation resistivity surrounding the borehole where the tool body 102 is located.

In some embodiments, the tool body 102 can be a drilling collar.

In some embodiments, each transceiver can be positioned equally-spaced on the tool body 102.

There is in no way limited to any particular number of transceiver or switch.

To conduct formation resistivity measurements, at least four transceivers can be involved: at least one transceiver acting in the transmitter mode to transmit compensating signals (i.e. the third transceiver 304), at least one transceiver acting in the transmitter mode to transmit measuring signals (i.e. the first transceiver 300), and at least a pair of transceivers acting in the receiver mode to receive compensating and measuring signals (i.e. the second and the fourth transceivers 302 and 306). The pair of transceivers acting in the receiver mode can be positioned on two sides of the transceiver transmitting compensating signals and substantially symmetrical with respect to it. The pair of transceivers acting in the receiver mode and the transceiver acting in the transmitter mode to transmit compensating signals can form a receiving unit 311. An example of a four-transceiver combination (the first transceiver 300, the second transceiver 302, the third transceiver 304, and the fourth transceiver 306) to conduct resistivity measurement and corresponding mathematical equations (15-29) are illustrated below.

In each measurement cycle, the third transceiver (the transceiver acting in the transmitter mode to transmit compensating signals; hereinafter referred to as “T_{c}” in equation) 304 can be energized and transmit compensating signals to the second transceiver (the transceiver acting in the receiver mode to receive compensating and measuring signals; hereinafter referred to as “R₁” in equation) 302 and the fourth transceiver (the transceiver acting in the receiver mode to receive compensating and measuring signals; hereinafter referred to as “R₂” in equation) 306 through surrounding formation first. The measured compensating signals at the second transceiver 302 and the fourth transceiver 306 when the third transceiver 304 fires can be expressed as follows.

Ã_{R1}^{Tc}=A_{R1}^{Tc}·e^{jφ}^{_{R1}}^{^{Tc}}=c_{Tc}^{err}·c_{R1(Tc)}^{err}·a_{R1}^{Tc}·e^{j(φ}^{_{R1}}^{^{Tc}}^{+φ}^{_{R1(Tc)}}^{^{err}}^{+φ}^{_{Tc}}^{^{err}}) (15)

Ã_{R2}^{Tc}=A_{R2}^{Tc}·e^{jφ}^{_{R2}}^{^{Tc}}=c_{Tc}^{err}·c_{R2(Tc)}^{err}·a_{R2}^{Tc}·e^{j(φ}^{_{R2}}^{^{Tc}}^{+φ}^{_{R2(Tc)}}^{^{err}}^{+φ}^{_{Tc}}^{^{err}}) (16)

where Ã_{R1}^{Tc} and Ã_{R2}^{Tc} are the measured compensating signals at the second transceiver 302 and the fourth transceiver 306 in complex format when the third transceiver 304 fires; where in Equations (15-16), the superscripts and subscripts represent the transceivers acting in the transmitter and receiver modes that are active when the signals are being measured; where the complex quantity Ã_{R1}^{Tc} is composed of measured compensating signal amplitude A_{R1}^{Tc} and measured compensating signal phase φ_{R1}^{Tc} at the second transceiver 302 when the third transceiver Tc fires; where the complex quantity Ã_{R2}^{Tc} is composed of measured compensating signal amplitude A_{R2}^{Tc} and measured compensating signal phase φ_{R2}^{Tc} at the fourth transceiver 306 when the third transceiver Tc fires; where a_{R1}^{Tc} and a_{R2}^{Tc} represent the formation related amplitude components of the measured compensating signals at the second transceiver 302 and the fourth transceiver 306 respectively when the third transmitter 304 fires; where φ_{R1}^{Tc} and φ_{R1}^{Tc} represent the formation related phase components of the measured compensating signals at the second transceiver 302 and fourth transceiver 306 respectively when the third transceiver 304 fires; where c_{Tc}^{err} and φ_{Tc}^{err} are induced errors in amplitude and phase by the third transceiver 304 (“compensating transmitter induced errors in amplitude and phase”) respectively on the pair of the second and fourth transceivers 302 and 306 when the third transceiver 304 fires; where c_{R1(Tc)}^{err} and c_{R2(Tc)}^{err} are the induced errors in amplitude by the second transceiver 302 and the fourth transceiver 306 (“receiver-induced errors in amplitude”) reflected in the pair of the second and fourth transceivers 302 and 306 respectively when the third transceiver 304 fires; where φ_{R1(Tc)}^{err} and φ_{R2(Tc)}^{err} are the induced errors in phase by the second transceiver 302 and the fourth transceiver 306 (“receiver-induced errors in phase”) reflected in the pair of the second and fourth transceivers 302 and 306 respectively when the third transceiver 304 fires.

Due to the symmetrical arrangement of the second transceiver 302 and forth transceiver 306 with respect to the third transceiver 304, both the receiver-induced errors and the compensating transmitter-induced errors, which may be caused by embedded antennas or corresponding circuits, can be cancelled out from the measured amplitudes and measured phases. Accordingly, the results of compensated measurements between electromagnetic signal amplitudes and phases on the second and fourth transceivers 302 and 306 for formation resistivity computation can become more accurate because only the formation related amplitude and phase components would be left in the compensated amplitude ratios and compensated differential phases. Corresponding mathematical algorithm can be shown in Equations (17-21) below.

To make compensated measurements between the electromagnetic signal amplitudes and phases at the second transceiver 302 and at the fourth transceiver 306 for computing formation resistivity, first, the complex ratio of measured compensating signals at the second transceiver 302 to the measured compensating signals at the fourth transceiver 306 when the third transceiver 304 fires can be derived from Equations (15-16) as follows.

$${\tilde{ρ}}_{Tc} = \frac{{A}_{R 2}^{Tc} \cdot {e}^{j {φ}_{R 2}^{Tc}}}{{A}_{R 1}^{Tc} \cdot {e}^{{jφ}_{R 1}^{Tc}}} = \frac{{c}_{R 2 ( Tc )}^{err}}{{c}_{R 1 ( T c )}^{err}} \cdot \frac{{a}_{R 2}^{Tc}}{{a}_{R 1}^{Tc}} \cdot {e}^{j ( {ϕ}_{R 2}^{Tc} - {ϕ}_{R 1}^{Tc} + {ϕ}_{R 2 ( Tc )}^{err} - {ϕ}_{R 1 ( Tc )}^{err} )} \qquad ( 17 )$$

where c_{Tc}^{err} and φ_{Tc}^{err}, the compensating transmitter induced errors in amplitude and phase respectively on the pair of the second transceiver 302 and the fourth transceiver 306 when the third transceiver 304 fires, are cancelled in Equation (17).

In Equation (17), we can further assume a_{R2}^{Tc}=a_{R1}^{Tc} and φ_{R2}^{Tc}=φ_{R1}^{Tc} because 1) the spacing between transceivers are relatively small, e.g. 8 inches, and therefore the borehole shape and formation properties can be assumed homogeneous in this range in the propagation logging art; and 2) the third transceiver 304 is substantially located in the midpoint of the pair of the second transceiver 302 and the fourth transceiver 306. Accordingly, the complex ratio for the third transceiver 304 firing becomes

$$\begin{matrix}{\tilde{ρ}}_{Tc} = \frac{{c}_{R 2 ( T c )}^{err}}{{c}_{R 1 ( Tc )}^{err}} \cdot {e}^{j ( {ϕ}_{R 2 ( Tc )}^{err} - {ϕ}_{R 1 ( Tc )}^{err} )} \\ = {ρ}_{RX}^{err} \cdot {e}^{j Δ {φ}_{RX}^{err}}\end{matrix} \qquad ( 18 )$$

where

$${ρ}_{RX}^{err} = \frac{{c}_{R 2 ( Tc )}^{err}}{{c}_{R 1 ( T c )}^{err}}$$

and Δφ_{RX}^{err}=φ_{R2(Tc)}^{err}−φ_{R1(Tc)}^{err} are the receiver-induced error factors in amplitude ratio and phase shift reflected in the pair of the second transceiver 302 and the fourth transceiver 306 respectively when the third transceiver 304 fires.

Alternatively, the complex ratio defined in Equation (18) can also be defined as follows.

$${\tilde{ρ}}_{Tc}^{′} = \frac{{\tilde{A}}_{R 1}^{Tc}}{{\tilde{A}}_{R 2}^{Tc}} = \frac{{c}_{R 1 ( Tc )}^{err}}{{c}_{R2 ( T c )}^{err}} \cdot {e}^{j ( {ϕ}_{R 1 ( Tc )}^{err} - {ϕ}_{R 2 ( Tc )}^{err} )} = \frac{1}{{ρ}_{RX}^{err}} \cdot {e}^{- j Δ {φ}_{RX}^{err}} \qquad ( 19 )$$

where ρ_{RX}^{err} and Δφ_{RX}^{err} share the same definition as in Equation (18). The two complex ratio definitions described in Equation (18) and Equation (19) are mathematically equivalent. Either Equation (18) or Equation (19) to be employed can depend on the location of the transceiver acting in the transmitter mode to transmit measuring signals relative to the receiving unit 311. Conventionally, the complex ratio is preferably defined as the signal of the farer transceiver acting in the receiver mode to the signal of the nearer transceiver acting in the receiver mode from the transceiver acting in the transmitter mode to transmit measuring signals.

Equations (18) and (19) show that after the third transceiver 304 firing, the differential phase between the compensating signal phases measured at the pair of the second transceiver 302 and the fourth transceiver 306 represents the receiver-induced error factor in phase (Δφ_{RX}^{err}=φ_{R2(Tc)}^{err}−φ_{R1(Tc)}^{err} or Δφ_{RX}^{err}=φ_{R1(Tc)}^{err}−φ_{R2(Tc)}^{err}) reflected in the pair of the second transceiver 302 and the fourth transceiver 306 and the amplitude ratio of the measured compensating signal amplitudes at the fourth transceiver 306 to the measured compensating signal amplitudes at the second transceiver 302 represents the receiver-induced error factor in amplitude

$$( {ρ}_{RX}^{err} = \frac{{c}_{R 2 ( Tc )}^{err}}{{c}_{R 1 ( T c )}^{err}} or {ρ}_{RX}^{err} = \frac{{c}_{R 1 ( Tc )}^{err}}{{c}_{R2 ( T c )}^{err}} )$$

reflected in the pair of the second transceiver 302 and the fourth transceiver 306.

After the third transceiver 304 firing, the first transceiver 300 is then energized and transmits electromagnetic signals/measuring signals to the pair of the second transceiver 302 and the fourth transceiver 306 through surrounding formation. To make compensated measurements between the electromagnetic signal amplitudes and phases reflected at the second transceiver 302 and the fourth transceiver 306, secondly, the complex ratio for the first transceiver (“the transceiver acting in the transmitter mode to transmit measuring signals; hereinafter referred to as Tₘ”) 300 firing can be defined as follows.

$${\tilde{ρ}}_{Tm} = \frac{{\tilde{A}}_{R 2}^{Tm}}{{\tilde{A}}_{R 1}^{Tm}} = \frac{{A}_{R 2}^{Tm} {e}^{{jφ}_{R 2}^{Tm}}}{{A}_{R 1}^{Tm} {e}^{{jφ}_{R 1}^{Tm}}} = \frac{{c}_{R 2 ( Tm )}^{err}}{{c}_{R 1 ( Tm )}^{err}} \cdot \frac{{a}_{R 2}^{Tm}}{{a}_{R 1}^{Tm}} \cdot {e}^{j ( {ϕ}_{R 2}^{Tm} - {ϕ}_{R 1}^{Tm} + {ϕ}_{R 2 ( Tm )}^{err} - {ϕ}_{R 1 ( Tm )}^{err} )} \qquad ( 20 )$$

where Ã_{R1}^{Tm} and Ã_{R2}^{Tm} are the measured measuring signals at the second transceiver 302 and the fourth transceiver 306 in complex format when the first transceiver 300 fires; where in Equations (20), the superscripts and subscripts represent the transceiver acting in the transmitter and receiver modes that are active when the signals are being measured; where the complex quantity Ã_{R1}^{Tm} and Ã_{R2}^{Tm} are composed of measured amplitude A_{R1}^{Tm} and A_{R2}^{Tm} and measured phases φ_{R1}^{Tm} and φ_{R2}^{Tm}, respectively; where a_{R1}^{Tm}, and a_{R2}^{Tm} represent the formation related amplitude components in the measured measuring signals at the second transceiver 302 and the fourth transceiver 306 respectively when the first transceiver 300 fires; where φ_{R1}^{Tm} and φ_{R2}^{Tm} represent the formation related phase components in the measured measuring signals at the second transceiver 302 and the fourth transceiver 306 respectively when the first transceiver 300 fires; c_{R1(Tm)}^{err} and c_{R2(Tm)}^{err} are induced errors in amplitude by the second transceiver 302 and the fourth transceiver 306 (“receiver-induced errors in amplitude”) reflected in the pair of the second transceiver 302 and the fourth transceiver 306 respectively when the first transceiver 300 fires; φ_{R1(Tm)}^{err} and φ_{R2(Tm)}^{err} are induced errors in phase by the second transceiver 302 and the fourth transceiver 306 (“receiver-induced errors in phase”) reflected in the pair of the second transceiver 302 and the fourth transceiver 306 respectively when the first transceiver 300 fires.

Finally, a compensated complex ratio can be derived by taking multiplication of \tilde{ρ}′_{Tc} in Equation (19) and \tilde{ρ}_{Tm} in Equation (20) as follows.

$${\tilde{ρ}}_{c} = {\tilde{ρ}}_{Tm} \cdot {\tilde{ρ}}_{Tc}^{′} = \frac{{\tilde{A}}_{R 2}^{Tm}}{{\tilde{A}}_{R 1}^{Tm}} \cdot \frac{{\tilde{A}}_{R 1}^{Tc}}{{\tilde{A}}_{R 2}^{Tc}} = \frac{{A}_{R 2}^{Tm} {e}^{{jφ}_{R 2}^{Tm}}}{{A}_{R 1}^{Tm} {e}^{{jφ}_{R 1}^{Tm}}} \cdot \frac{{A}_{R 1}^{Tc} {e}^{{jφ}_{R 1}^{Tc}}}{{A}_{R 2}^{Tc} {e}^{{jφ}_{R 2}^{Tc}}} = \frac{{a}_{R 2}^{Tm}}{{a}_{R 1}^{Tm}} \cdot {e}^{j ( {ϕ}_{R 2}^{Tm} - {ϕ}_{R 1}^{Tm} )} \qquad ( 21 )$$

After taking multiplication of \tilde{ρ}′_{Tc} and \tilde{ρ}_{Tm}, both the transmitter induced errors and the receiver-induced errors in amplitude and phase can be eliminated and only the formation related information (amplitude and phase components) are remained.

To reach the expression of Equation (21), assumptions have been taken that the receiver-induced errors in amplitude and phase when the third transceiver 304 fires are the same as the receiver-induced errors in amplitude and phase when the first transceiver 300 fires (c_{R1(Tc)}^{err}=c_{R1(Tm)}^{err}, c_{R2(Tc)}^{err}=c_{R2(Tm)}^{err}, φ_{R1(Tc)}^{err}=φ_{R1(Tm)}^{err}, and φ_{R1(Tc)}^{err}=φ_{R2(Tm)}^{err}), based on the property consistency of the transceiver acting in the receiver mode within a transceiver transmitting compensating signals and a transceiver transmitting measuring signals firing cycle. It shows the importance of determination of the complex ratio \tilde{ρ}_{Tc} in Equation (18) or \tilde{ρ}′_{Tc} in Equation (19). To perform compensation operation between the third transceiver 304 and the first transceiver 300, the complex ratio \tilde{ρ}_{Tc} in Equation (18) or \tilde{ρ}′_{Tc} in Equation (19) should be determined adequately to eliminate or reduce the receiver-induced errors in the measurement when the first transceiver 300 fires. If the complex ratio \tilde{ρ}_{Tc} or \tilde{ρ}′_{Tc} is wrongly determined, the receiver-induced errors in phase and amplitude reflected in the pair of the second transceiver 302 and the fourth transceiver 306 when the first transceiver 300 fires would be doubled, instead of being eliminated or reduced.

In some embodiments, a compensation controller 318 (disclosed in FIG. 3B) can be coupled to the third transceiver 304, the second transceiver 302 and the fourth transceiver 306 to help determine the receiver-induced errors in amplitude and phase reflected in the pair of the second transceiver 302 and the fourth transceiver 306 when the third transceiver 304 fires.

The magnitude and phase of the compensated complex ratio \tilde{ρ}_{c} are called a compensated amplitude ratio and a compensated differential phase respectively for computing formation resistivity later. The compensated amplitude ratio and the compensated differential phase can be calculated using the measured signals at the second transceiver 302 and the fourth transceiver 306 when the third transceiver 304 and the first transceiver 300 fire respectively and can be denoted as follows.

$$\begin{matrix}{ρ}_{c} = \sqrt{\frac{{A}_{R 2}^{Tm}}{{A}_{R 1}^{Tm}} \cdot \frac{{A}_{R 1}^{Tc}}{{A}_{R 2}^{Tc}}} & ( 22 ) \\ Δ {φ}_{c} = \frac{( {φ}_{R 2}^{Tm} - {φ}_{R 1}^{Tm} ) + ( {φ}_{R 1}^{Tc} - {φ}_{R 2}^{Tc} )}{2} & ( 23 )\end{matrix}$$

However, based on results of the mathematical deduction through Equations (17-21), only the formation related amplitude and phase components would be left in the compensated amplitude ratios and compensated differential phases as shown in Equations (22-23). Therefore, the final formation related amplitude ratio and differential phase can be shown as follows.

$$\begin{matrix}{ρ}_{c} = \sqrt{\frac{{a}_{R 2}^{Tm}}{{a}_{R 1}^{Tm}} \cdot \frac{{a}_{R 1}^{Tc}}{{a}_{R 2}^{Tc}}} & ( 24 ) \\ Δ {φ}_{c} = ( {ϕ}_{R 2}^{Tm} - {ϕ}_{R 1}^{Tm} ) & ( 25 )\end{matrix}$$

Conventionally, the complex ratio is preferably defined as the signal of the farer transceiver acting in the receiver mode to the signal of the transceiver acting in the receiver mode from the transceiver acting in the transmitter mode to transmit measuring signals. Therefore, if the first transmitter 300 is deployed axially below the fourth transceiver 306, the compensated amplitude ratio and the compensated differential phase can be denoted as follows

$$\begin{matrix}{ρ}_{c} = \sqrt{\frac{{A}_{R 1}^{Tm}}{{A}_{R 2}^{Tm}} \cdot \frac{{A}_{R 2}^{Tc}}{{A}_{R 1}^{Tc}}} & ( 26 ) \\ Δ {φ}_{c} = \frac{( {φ}_{R 1}^{Tm} - {φ}_{R 2}^{Tm} ) + ( {φ}_{R 2}^{Tc} - {φ}_{R 1}^{Tc} )}{2} & ( 27 )\end{matrix}$$

Also based on results of the mathematical deduction through Equations (17-21), the final formation related amplitude ratio and differential phase can be shown as follows.

$$\begin{matrix}{ρ}_{c} = \sqrt{\frac{{a}_{R 1}^{Tm}}{{a}_{R 2}^{Tm}} \cdot \frac{{a}_{R 2}^{Tc}}{{a}_{R 1}^{Tc}}} & ( 28 ) \\ Δ {φ}_{c} = ( {ϕ}_{R 1}^{Tm} - {ϕ}_{R 2}^{Tm} ) & ( 29 )\end{matrix}$$

FIG. 3B illustrates a schematic representation, partially in block diagram form, of an apparatus including multiple transceivers which include multiple switches further include transmitter circuits 314 and receiver circuits 316 configured to generate and receive compensating signals and measuring signals according to some embodiments of the present invention. When the transceiver is acting in the transmitter mode, the transmitter circuit 314 can be set to work and the receiver circuit 316 can be turned off. When the transceiver is acting in the receiver mode, the receiver circuit 316 can be set to work and the transmitter circuit can be turned off.

In some embodiments, the compensation controller 318 can be coupled to the transmitter circuit 314 and the receiver circuit 316 and configured to control the magnitude of the compensating signals to be transmitted by the transceiver transmitting compensating signals, to adequately determine the receiver-induced error factors in amplitude and phase reflected on the pair of transceiver acting in the receiver mode when the transceiver transmitting compensating signals fires, and further to eliminate the receiver-induced errors in amplitude and phase reflected in the pair of transceivers acting in the receiver mode when the transceiver transmitting measuring signals fires.

In some embodiments, a processor 320 can be coupled to the compensation controller 318, the transmitter circuit 314, and the receiver circuit 316, and configured to control the operation of the tool system and help the compensation controller 318 determine receiver-induced error factors in amplitude and phase reflected in the pair of transceiver acting in the receiver mode when the transceiver transmitting compensating signals fires and compute the compensated amplitude ratio and the compensated differential phase after the transceiver transmitting measuring signals fires. If the compensation controller 318 is connected to a transceiver transmitting measuring signals, instead of compensating signals, the compensation controller 318 doesn't need to work and the corresponding transmitter circuit 314 can be connected to the processor 320 directly. Also, if the compensation controller 318 is connected to a transceiver receiving compensating and measuring signals, the compensation controller 318 doesn't need to work and the corresponding receiver circuit 316 can be connected to the processor 320 directly.

In some embodiments, a storage device 322 can be coupled to the processor 320 and stored with a conversion chart, which is for converting the computed compensated amplitude ratio and compensated differential phase into corresponding formation resistivity.

In some embodiments, the processor 320 can further compute the formation resistivity according to the conversion chart stored in the storage device 322.

In some embodiments, the transmitter circuit 314, the receiver circuit 316, the compensation controller 318, the processor 320, and the storage device 322 can be all embedded with the transceivers.

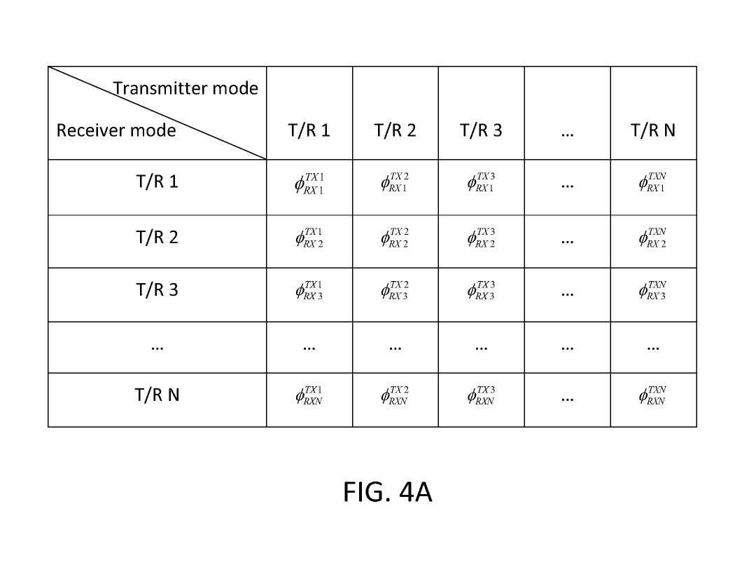

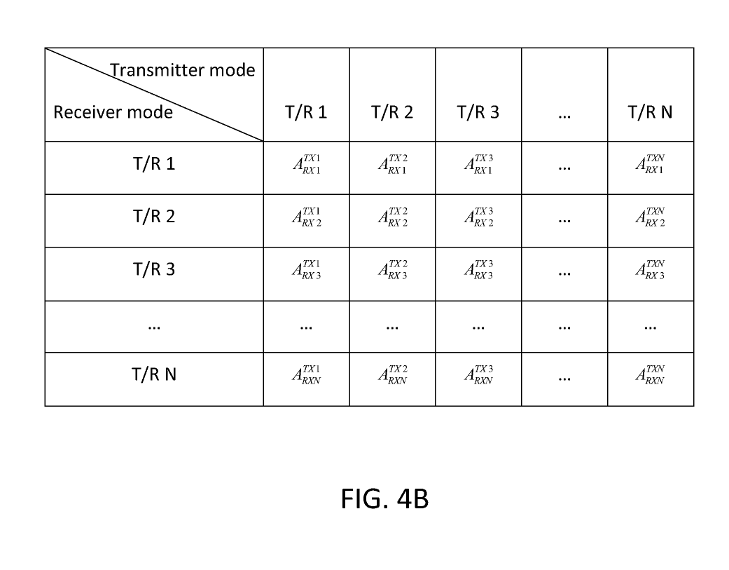

Since each transceiver disclosed in FIGS. 3A and 3B can freely switch between the transmitter mode and the receiver mode, a series of transceivers deployed on the tool body 102 can have multiple combinations (offsets) of the receiving unit and the transceiver transmitting measuring signals. It means that if more than four transceivers are used, multiple depths of investigation can be achieved. FIG. 4A listed a matrix of measured phases after one cycle of measurement when N transceivers in total are in use. φ_{RXi}^{TXj} in the FIG. 4A denotes the measured signal phase received at the i^{th} transceiver acting in the receiver mode when the j^{th} transceiver acting in the transmitter mode fires. FIG. 4B listed a matrix of measured amplitude after one cycle of measurement when N transceivers in total are in use. A_{RXi}^{TXj} in the FIG. 4B denotes the measured signal amplitude received at the i^{th} transceiver acting in the receiver mode when the j^{th} transceiver acting in the transmitter mode fires.

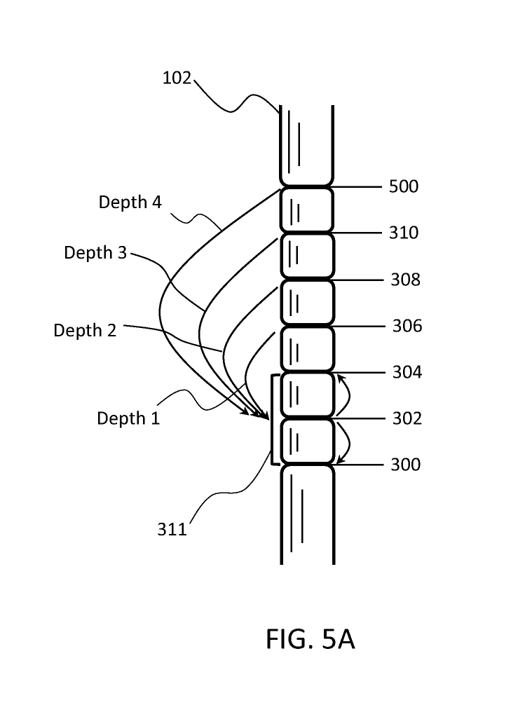

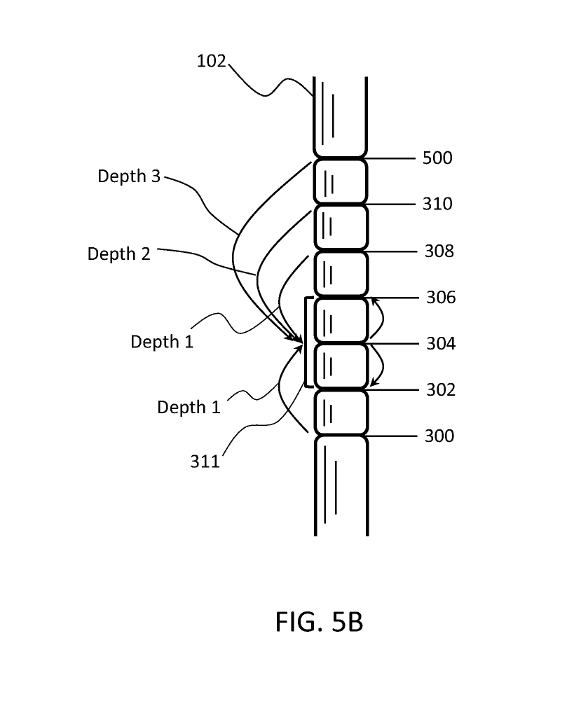

FIG. 5A discloses the first measurement mode of one embodiment of the present invention. In FIG. 5A, seven substantially equally-spaced transceivers are in use. The first transceiver 300, the second transceiver 302, and the third transceiver 304 form a receiving unit 311. The first transceiver 300 and the third transceiver 304 are acting in the receiver mode and the second transceiver 302 is acting in the transmitter mode to transmit compensating signals. The rest of transceivers: the fourth transceiver 306, the fifth transceiver 308, the sixth transceiver 310, and the seventh transceiver 312 are acting in the transmitter mode to transmit measuring signals. The fourth transceiver 306 is the nearest transceiver from the receiving unit 311 (hereinafter referred to as “Depth 1 in mode 1”) and therefore it offers the shallowest depth of investigation. The fifth transceiver 308 is the second nearest transceiver from the receiving unit 311 (hereinafter referred to as “Depth 2 in mode 1”) and therefore it offers the second shallowest depth of formation investigation. The seventh transceiver 500 is the farthest transceiver from the receiving unit 311 (hereinafter referred to as “Depth 4 in mode 1”) and therefore it offers the deepest depth of formation investigation. FIG. 5A shows that when N transceivers operate in the first measurement mode, N−3 depths of formation investigation can be achieved.

FIG. 5B disclose the second measurement mode of the embodiment of the present invention. In FIG. 5B, same as in FIG. 5A, seven substantially equally-spaced transceivers are in use. The receiving unit 311 now moves upward. The second transceiver 302, the third transceiver 304, and the fourth transceiver 306 form the receiving unit 311. The second transceiver 302 and the fourth transceiver 306 are acting in the receiver mode and the third transceiver 304 is acting in the transmitter mode to transmit compensating signals. The rest of transceivers: the first transceiver 300, the fifth transceiver 308, the sixth transceiver 310, and the seventh transceiver 312 are acting in the transmitter mode to transmit measuring signals. The first transceiver 300 and the fifth transceiver 306 is the nearest transceiver from the receiving unit 311 (hereinafter referred to as “Depth 1 in mode 2”) and therefore it offers the shallowest depth of investigation. The seventh transceiver 500 is the farthest transceiver from the receiving unit 311 (hereinafter referred to as “Depth 3 in mode 2”) and therefore it offers the deepest depth of investigation. FIG. 5B shows that when N transceivers operate in the second measurement mode, N−4 depths of investigation can be achieved.

In brief, N transceivers can have N−2 measurement modes and N−3 maximum number of depth of investigation. The first mode and the (N−2)^{th} mode can conduct the most number of depth of investigation. The [(n−1)/2]^{th} mode for odd number of transceiver and both the [N/2−1]^{th} and [N/2]^{th} modes for even number of transceiver can conduct the fewest number of depth of investigation.

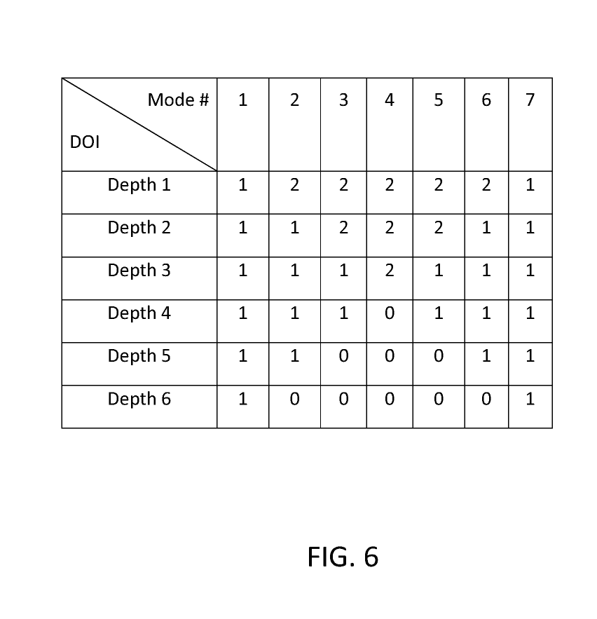

The apparatus according to the present invention can work in single mode, multi-mode, or full mode. In the full mode, a specific depth of formation investigation will be measured multiple times. FIG. 6 lists the number of each depth of investigation being measured in each mode with 9 transceivers in use. FIG. 6 shows that 9 transceivers can operate in 7 modes and obtain 6 depths of investigation. The deepest Depth 6 only can be measured in the first and the seventh measurement modes. However, the shallowest Depth 1 can be measured in every measurement mode and even can be measured twice in the 2^{nd}˜6^{th} measurement modes.

To retrieve more specific measurement results, for each depth, the measurement results in different modes can be averaged according to following two methods. The first method is to average all measurement results of the same depth. The second method is to average the results of measurements conducting in modes which share substantially the same zone of formation. For example, the Depth 6 in Mode 1 and 7 cover substantially the same zone of formation.

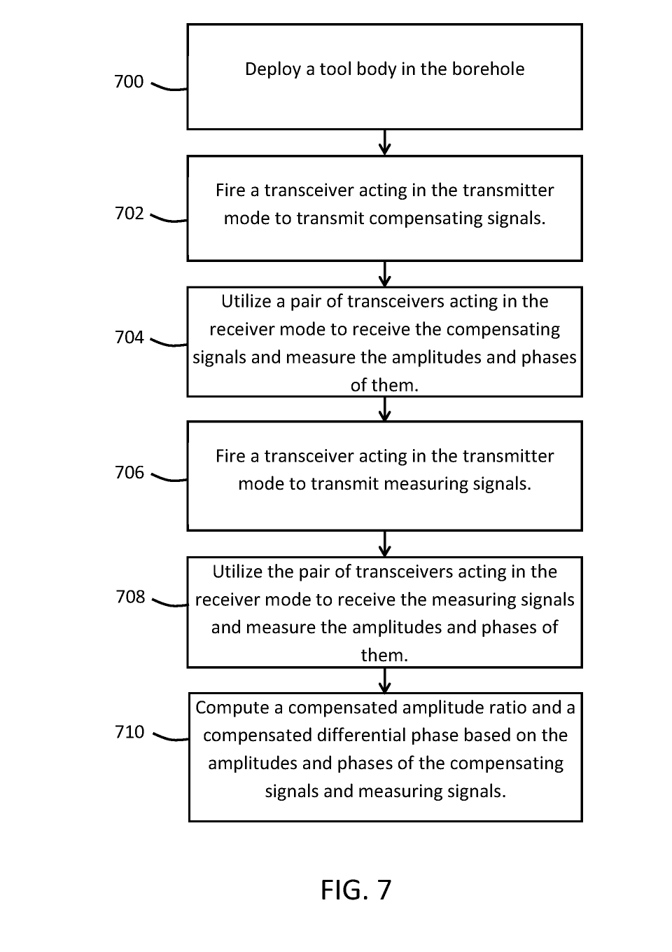

FIG. 7 illustrates a flow chart of a method for measuring formation resistivity. The method of measuring formation resistivity in a subterranean borehole includes deploying a tool body in the borehole 700; the tool body deployed with an array of transceivers including at least one transceiver acting in a transmitter mode to transmit measuring signals, at least one transceiver acting in the transmitter mode to transmit compensating signals, and at least a pair of transceivers acting in a receiver mode to receive the compensating signals and the measuring signals; the transceiver transmitting compensating signals being positioned substantially at the midpoint of the pair of transceivers acting in the receiver mode, firing the transceiver acting in the transmitter mode to transmit compensating signals 702, utilizing the pair of transceivers in the receiver mode to receive the compensating signals and measure the amplitudes and phases of them 704, firing the transceiver acting in the transmitter mode to transmit measuring signals 706, utilizing the pair of transceivers acting in the receiver mode to receive the measuring signals and measure the amplitudes and phases of them 708, and computing a compensated amplitude ratio and a compensated differential phase based on the amplitudes and phases of the compensating signals and the measuring signals 710.

In some embodiments, the method of measuring formation resistivity in a subterranean borehole further includes the step of averaging the compensated amplitude ratios and the compensated differential phases computed from multiple pairs of transceivers acting in the receiver mode which have substantially the same distance form the midpoint of the pairs of transceivers acting in the receiver mode to the transceiver transmitting measuring signals for improving measurement accuracy.

In some embodiments, the multiple pairs of transceivers acting in the receiver mode share a substantially the same zone of formation from the midpoint of them to the transceiver transmitting measuring signals.

In some embodiments, the method of measuring formation resistivity in a subterranean borehole further includes the step of providing a conversion chart to help convert the computed compensated amplitude ratio and compensated differential phase into corresponding formation resistivity.

In some embodiments, the method of measuring formation resistivity in a subterranean borehole further includes the step of providing a compensation controller coupled to the transceivers to determine the receiver-induced errors in amplitude and phase reflected in the pair of transceivers acting in the receiver mode when the compensating signals are transmitted to reduce receiver-induced errors in amplitude and phase reflected in the pair of transceivers acting in the receiver mode when the measuring signals are transmitted.

However, the present invention is in no way limited to any particular order of steps or requires any particular step illustrated in FIG. 7.

In conclusion, exemplary embodiments of the present invention stated above may provide several advantages as follows. The present invention utilizes transceivers with both transmitter and receiver modes to conduct compensation measurement of formation resistivity and therefore the length of the logging tool can be shortened and the manufacturing costs can be decreased accordingly. Also, multiple depths of formation investigation can be achieved by deploying multiple transceivers. Lastly, the resistivity measurement can be conduct in single, multiple, and full modes to obtain more data to calculate more accurate results.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. An apparatus for measuring formation resistivity in logging while drilling application comprising:
a tool body;
multiple transceivers deployed on the tool body;
wherein each transceiver further comprising a switch to control the transceiver to switch between a transmitter mode and a receiver mode;
wherein at least one transceiver acting in the transmitter mode to transmit compensating signals, at least one transceiver acting in the transmitter mode to transmit measuring signals, and at least a pair of transceivers acting in the receiver mode, positioned on two sides of the transceiver transmitting compensating signals, and substantially symmetrical with respect to it, to receive the compensating signals and the measuring signals; and
wherein the pair of transceivers acting in the receiver mode measure the amplitudes and phases of the compensating signals and the measuring signals in a sequential order and computes a compensated amplitude ratio and a compensated differential phase accordingly.

2. The apparatus according to claim 1 wherein each transceiver comprises a transmitter circuit and a receiver circuit configured to transmit and receive compensating and measuring signals respectively.

3. The apparatus according to claim 1 further comprises a compensation controller coupled to each transceiver to help determine receiver-induced error factors in amplitude and phase reflected in the pair of transceivers acting in the receiver mode when the compensating signals are transmitted for calibrating receiver-induced error in amplitude and phase reflected in the pair of transceivers acting in the receiver mode when the measuring signals are transmitted.

4. The apparatus according to claim 3 further comprises a processor coupled to the transceivers and the compensation controller and configured to help the compensation controller determine receiver-induced error factors in amplitude and phase reflected in the pair of transceivers acting in the receiver mode when the compensating signals are transmitted and to help compute the compensated amplitude ratio and the compensated differential phase after the measuring signals are transmitted.

5. The apparatus according to claim 4 further comprises a storage device coupled to the processor and stored with a conversion chart, which is for converting the compensated amplitude ratio and the compensated differential phase into corresponding formation resistivity.

6. The apparatus according to claim 1 wherein the compensated amplitude ratio is expressed by an equation
$${ρ}_{c} = \sqrt{\frac{{A}_{R 1}^{Tc}}{{A}_{R 2}^{Tc}} \cdot \frac{{A}_{R 2}^{Tm}}{{A}_{R 1}^{Tm}}}$$
where A_{R1}^{Tm}, and R_{R2}^{Tm} represent signal amplitudes of the measuring signals measured at the pair of transceiver acting in the receiver mode respectively when the measuring signals are transmitted; superscript Tm represents the transceiver transmitting measuring signals; subscript R2 represents the transceiver acting in the receiver mode; and subscript R1 represents another transceiver acting in the receiver mode which is closer to the transceiver transmitting measuring signals than the R2 is.

7. The apparatus according to claim 1 wherein the corresponding compensated differential phase is expressed by an equation
$$Δ {φ}_{c} = \frac{( {φ}_{R 1}^{Tc} - {φ}_{R 2}^{Tc} ) + ( {φ}_{R 2}^{Tm} - {φ}_{R 1}^{Tm} )}{2}$$
where φ_{R1}^{Tm} and φ_{R2}^{Tm} represent the signal phase of the measuring signals measured at the pair of transceiver acting in the a receiver mode respectively when the measuring signals are transmitted; superscript Tm represents the transceiver transmitting measuring signals; subscript R2 represents the transceiver acting in the receiver mode; and subscript R1 represents another transceiver acting in the receiver mode which is closer to the transceiver transmitting measuring signals than the R2 is.

8. The apparatus according to claim 1 wherein the multiple transceivers are substantially equally spaced from each other.

9. The apparatus according to claim 1 wherein the compensated amplitude ratio and the compensated differential phase are average results of multiple compensated amplitude ratios and the compensated differential phases computed from multiple pairs of transceivers acting in the receiver mode which have substantially the same distance from the midpoint of the pairs of transceivers to the transceiver transmitting measuring signals.

10. The apparatus according to claim 9 wherein the multiple pairs of transceivers acting in the receiver mode share substantially the same zone of formation from the midpoint of them to the transceiver transmitting measuring signals.

11. The apparatus according to claim 1 wherein each transceiver comprises at least one antenna for transmitting or receiving signals.

12. The apparatus according to claim 1 wherein the tool body is a drilling collar.

13. A logging while drilling tool comprising:
a tool body;
one or more transceivers acting in a transmitter mode to transmit measuring signals;
a receiving unit formed by a pair of transceivers acting in a receiver mode and a transceiver acting in the transmitter mode to transmit compensating signals and positioned substantially at the midpoint of the pair of transceivers; and
wherein the pair of transceivers acting in the receiver mode measure the amplitudes and phases of the compensating signals and the measuring signals in a sequential order and computes a compensated amplitude ratio and a compensated differential phase accordingly.

14. The logging while drilling tool according to claim 13 further comprises a compensation controller coupled to the transceivers to help determine receiver-induced error factors in amplitude and phase reflected in the pair of transceivers acting in the receiver mode when the compensating signals are transmitted for calibrating receiver-induced error in amplitude and phase reflected in the pair of transceivers acting in the receiver mode when the measuring signals are transmitted.

15. The logging while drilling tool according to claim 13 wherein the transceivers are substantially equally spaced from each other.

16. A method for measuring formation resistivity in a subterranean borehole comprising:
deploying a tool body in the borehole; the tool body deployed with an array of transceivers including at least one transceiver acting in a transmitter mode to transmit measuring signals, at least one transceiver acting in a transmitter mode to transmit compensating signals, and at least a pair of transceivers acting in a receiver mode to receive the compensating signals and the measuring signals; the transceiver transmitting compensating signals being positioned substantially at the midpoint of the pair of transceivers acting in a receiver mode;
firing the transceiver acting in the transmitter mode to transmit compensating signals;
utilizing the pair of transceivers acting in the receiver mode to receive the compensating signals and measure the amplitudes and phases of them;
firing the transceiver acting in the transmitter mode to transmit measuring signals;
utilizing the pair of transceiver acting in the receiver mode to receive the measuring signals and measure the amplitudes and phases of them; and
computing a compensated amplitude ratio and a compensated differential phase based on the amplitudes and phases of the compensating signals and the measuring signals.

17. The method according to claim 16 further comprises averaging the compensated amplitude ratios and the compensated differential phases computed from multiple pairs of transceivers acting in the receiver mode which have substantially the same distance from the midpoint of the pairs of transceivers acting in the receiver mode to the transceiver transmitting measuring signals for improving measurement accuracy.

18. The method according to claim 17 wherein the multiple pairs of transceivers acting in the receiver mode share a substantially the same zone of formation from the midpoint of them to the transceiver transmitting measuring signals.

19. The method according to claim 16 further comprises providing a compensation controller coupled to the transceivers to help determine receiver-induced error factors in amplitude and phase reflected in the pair of transceivers acting in the receiver mode when the compensating signals are transmitted to reduce receiver-induced errors in amplitude and phase reflected in the pair of transceiver acting in the receiver mode when the measuring signals are transmitted.

20. The method according to claim 16 further comprises providing a conversion chart to help convert the computed compensated amplitude ratio and the compensated differential phase into corresponding formation resistivity.
